(19) United States
(12) Patent Application Publication
(10) Pub. No.: US 2011/0168797 A1
(43) Pub. Date: Jul. 14, 2011

(54) METHOD OF WEAKENING A HURRICANE

(76) Inventor: Calvin E. Neymeyer, Clinton, IA (US)

(21) Appl. No.: 12/840,287

(22) Filed: Jul. 20, 2010

Related U.S. Application Data
(60) Provisional application No. 61/271,353, filed on Jul. 20, 2009.

(51) Int. Cl. A01G 15/00

(52) U.S. Cl. 239/2.1

(57) ABSTRACT

The present invention is directed to a method of weakening a hurricane. In one aspect of the invention, hurricane development is weakened by identifying pre-hurricane systems and inducing rainfall therein. In another aspect of the invention, a hurricane is weakened by disrupting the inner winds surrounding the hurricane's eye with a water-absorbent substance such as oatmeal. In another aspect of the invention, the hurricane is weakened by cooling the air in front of the hurricane system.

### CROSS-REFERENCE TO RELATED APPLICATIONS

The present application claims the benefit of U.S. Provisional Application No. 61/271,353, filed Jul. 20, 2009.

### BACKGROUND

The siege of hurricanes assaulting the United States in the past few years have produced horrendous amounts of misery, grief, expense, damage and considerable talk. Our current strategy of observing, tracking, predicting and describing have provided little deterrent effect on these storms.

A number of suggestions and approaches to dealing with hurricanes are known, mainly dealing with cloud seeding. Methods for reducing the strength of a hurricane's inner winds or for suppressing these storms in their infancy has not drawn enough attention.

The benefit of reducing the incidence and/or strength of a hurricane includes saving lives and preserving cities and property from hurricane damage. Such damage costs millions if not billions of dollars of damage every year, and sometimes takes a great many lives.

### SUMMARY

The present invention is directed in part to the instituting at least one line of defense against hurricanes. One line of defense may be off the western coast of North Africa. Another line of defense may be in the lands of the Western Hemisphere contiguous to and in the Caribbean Sea, Gulf of Mexico and the eastern shores of the United States.

The present invention is directed in part to assessing the strength and/or weakness of low pressure systems exiting the western shores of North Africa. The present invention is directed in part to identifying certain low pressure systems capable of becoming hurricanes. Weakening procedures are to be undertaken to reduce the capability of a system to develop into a hurricane. These weakening procedures preferably include different forms of cloud-seeding to stimulate additional rainfall from suspect systems thereby weakening them.

The present invention is directed in part to a method of disrupting hurricane functioning by use of N-Blocks (Mobile Resistance Blocks). Without being bound by theory, this method of using an inward N-Block increases air pressure within the storm's center to disrupt its organization.

The present invention is directed in part to a method of using an Outward N-Block. This creates a “Blow-Out” condition, weakening the storm by creating wind disorganization.

The present invention is directed in part to a method of using an inward N-Block and outward N-Block in combination to weaken a hurricane.

The present invention is directed in part to a method of causing a directional change in the hurricane's path leading the storm away from more sensitive areas and/or shift a hurricane to an area unable to transport the storm to other areas, namely, the doldrum area, rendering the storm essentially harmless. The storm will spin itself out.

The present invention is directed in part to a method using a water-absorbent material to create N-blocks, preferably oatmeal which is easily available, transportable, inexpensive and environmentally acceptable.

The present invention is directed in part to a procedural method of minimizing hurricane destruction by proper timing, suitable location and charting the hurricane's travel speed.

### BRIEF DESCRIPTION OF THE DRAWINGS

FIG. 1 shows a diagrammatic representation of a method of the present invention employing an inward N-block.

FIG. 2 shows a diagrammatic representation of a method of the present invention employing an outward N-block.

FIG. 3 shows a diagrammatic representation of a method of the present invention employing an inward and an outward N-block.

FIG. 4 shows a diagrammatic representation of a method of the present invention employing an inward N-block.

### DETAILED DESCRIPTION

A method of the present invention is directed to suppressing the development of a hurricane by first identifying a low pressure system as a pre-hurricane system, and then inducing rainfall within the pre-hurricane system. Without being hound by theory, it is believed that inducing rainfall therein will increase the atmospheric pressure in the system, thus suppressing the development of a hurricane.

For the purposes of the present invention, a hurricane is meant to refer to a tropical cyclone having wind speed of at least 74 miles per hour (mph). Typically, a hurricane is also defined as located over the Atlantic or Pacific Ocean, north of the equator and east of the International Date Line. While the disclosure herein is directed to this typical location of a hurricane, a hurricane according the present invention may include a typhoon, which is a tropical cyclone having wind speed of at least 74 mph, located over the northwestern Pacific Ocean, north of the equator and west of the International Date Line. Preferably, a hurricane's wind speed is from about 75 to about 200 mph, more preferably from about 80 to about 130 mph, and most preferably from about 85 to about 120 mph.

For the purposes of the present invention, a tropical cyclone is meant to refer to an area of low atmospheric pressure with winds blowing around it (counterclockwise in the Northern hemisphere). Typically, a tropical cyclone forms over a tropical ocean with a core warmer than the surrounding atmosphere.

Regarding the line of defense off the western coast of North Africa, a meteorological air base is to be located off the western shores of North Africa to lessen the potential danger of these exiting storms. The base is preferably above the tropical rainfall zone, provides easy access to suspect storms, is capable of being able to support an air base and/or is politically secure. A preferred location is the Cape Verde Islands and/or land areas in its immediate vicinity. A line of defense in this area could reduce the number of hurricanes striking the United States and other areas of the Western Hemisphere.

Some of the hurricanes reaching the United States' shores develop from low pressure systems from countries in Western Africa. These countries, from North to South, include one or more of Mauritania, Senegal, Gambia, Guinea-Bissau, Guinea, Sierra Leone and Liberia; preferably, one or more of Mauritania, Senegal, Gambia, and Guinea-Bissau. In this section of Africa, low pressure systems enter one or more countries from the east, cross the lands from east to west and, after dropping most of their precipitation along the west coastal areas, exit the African continent out into the mid-Atlantic Ocean. Some of these coastal regions receive as much as 194 inches of rain a year.

The rainy season of all the above-mentioned countries fit within the hurricane parameters of the U.S. hurricane season, June 1 to December 1. There is a slight difference with Liberia, whose rainy season ranges from April 1 to October 1. However, Liberia appears not to be a large contributor of potential storms capable of becoming hurricanes because of its southerly location.

The amount of rainfall increases from the most northern countries to the southern ones. Northern Mauritania, the most northern area, receives about 1 inch of rainfall a year but Southern Mauritania averages 12-24 inches of rainfall a year. Crossing south, Northern Senegal receives 12-24 inches of rainfall a year, and Southern Senegal receives 40-60 inches of rainfall a year. Continuing south into The Gambia, the coastal city of Banjul averages 51 inches of rainfall a year. Further south, in Guinea Bissau, the coastal city of Bissau averages 76 inches of rainfall a year. Progressing south, the coastal city of Canarky, Guinea, receives an average of 194 inches of rainfall a year. Freetown, in Sierra Leone, south of Guinea: 135 inches of rainfall a year. Further toward the equator, Monrovia, Liberia, averages 163 inches of rainfall a year.

From the amount of rainfall these areas receive, there must be a considerable number of low pressure systems delivering these amounts of precipitation, whether they are large systems or more numerous small systems. The coastal areas of these countries receive the most rain, probably due to the proximity of ocean moisture. This indicates the storms are strong and active as they leave African shores and begin drifting over the mid-Atlantic area.

These low pressure systems do not appear to have much self-propulsion capacity. They are driven mainly by the normal prevailing meteorological forces present at the time. The trade winds blow more strongly over the ocean than over Africa. These winds push a number of these systems southwest and/or westward toward the Western Hemisphere. Once these low pressure systems begin drifting over the mid-Atlantic, roughly the area between 10 degrees and 20 degrees North latitude, there is considerable heat and energy to provide for hurricane development. With the aid of the enormous heat, moisture and low pressure environment available from the tropical water, a percentage develop into tropical depressions and then into future hurricanes. This area is part of the intertropical convergence zone which area is already somewhat low pressure because of the rising hot air from around the equator. This is a natural incubator for developing low pressure storms and/or aiding already active low pressure systems to refuel and increase in size and strength. The approximate distance from these above-mentioned African countries to the Caribbean Sea area is close to 3000 miles. Plenty of time and fuel to develop into the monster storms we have come to fear and dread.

Since the trade winds blow from northeast to southwest, toward the equator, storms coming from the southernmost countries (Sierra Leone, Liberia and Guinea) are less likely to develop into hurricanes. For instance, a system coining from Canarky, Guinea, average rainfall 194 inches, would be pushed in a southwest direction toward the equator. In order to reach the Caribbean Basin or the gulf of Mexico, common tracks for hurricanes, the system would have to travel at least 1000 mile northward. As hurricanes have little capacity for self-propulsion, and the trade winds blow southwest and the system would have to travel northwest (cutting across normal trade wind routes of travel), a hurricane originating from Guinea is less likely than more northern countries.

Most likely, the systems from the southern countries are blown toward the equator where they encounter the doldrums area, an area of relative calm centered north and south of the equator. Because any propelling winds are light, the storms simply die out and “wither on the vine”. This probably is the reason that Northeast South America is not afflicted by hurricanes. The trade winds don't extend far enough south to propel them into northern and eastern South America.

Not all low pressure systems leaving Africa have sufficient strength to eventually develop into hurricanes. The strength of a low pressure system is measured by the air pressure at its center. The lower the readings, the stronger the system. The strongest (lowest low pressure) storms have the highest potential to become hurricanes.

To suppress the development of a hurricane, according to the present method, a low pressure system off the Western Coast of Mauritania, Senegal, Gambia, Guinea-Bissau, Guinea, Sierra Lone and Liberia; preferably, one or more of Mauritania, Senegal, Gambia, and Guinea-Bissau, also preferably between June 1 and December 1 according to the United States calendar, more preferably between August 1 and November 1 will be identified by an identifying step.

Step 1: Identifying Step

The identifying step includes measuring the atmospheric pressure of a low pressure system and preferably includes measuring one or more other parameters such as the temperature of ocean water associated with the low pressure system (that is, ocean water beneath the physical area of the low pressure system in the atmosphere).

A low pressure system according to the present invention is a system having a pressure of not more than 29.5 inches, preferably according to at least one measurement. A pre-hurricane system is a low pressure system having the potential to become a hurricane in the manner discussed throughout this application. Several factors may be taken into account to identify a pre-hurricane system, as illustrated for example below.

A low pressure system at least three miles off the coast of at least one of Mauritania, Senegal, Gambia, Guinea-Bissau, Guinea, Sierra Leone and Liberia, preferably at least one of Mauritania, Senegal, Gambia, and Guinea-Bissau (and preferably not farther than ten miles off said coast), may be identified as a pre-hurricane system if at least one measurement of atmospheric pressure in the low pressure system is not more than 27 inches. Preferably, more than one measurement of atmospheric pressure is not more than 27 inches; most preferably, an average of atmospheric pressures in the system is not more than 27 inches. The measurement of atmospheric pressure in low pressure systems is well-known in the art; any reliable means for measuring atmospheric pressure may be used.

In the event that at least one atmospheric pressure measurement of a low pressure system is greater than 27 inches and less than about 28.5 inches, preferably less than 28 inches, the present method further includes a step of closely monitoring the system, including for instance further monitoring the atmospheric pressure of the system and/or monitoring the temperature of the ocean water associated with the low pressure system. In the event that at least one atmospheric pressure measurement of a low pressure system is greater than about 28.5 inches and not more than 29.5 inches, the present method includes a step of further monitoring the atmospheric pressure of the system. A low pressure system is unlikely to be identified as a pre-hurricane system if the pressure of the system remains above about 29 inches.

Also a low pressure system at least three miles off the coast of at least one of Mauritania, Senegal, Gambia, Guinea-Bissau, Guinea, Sierra Leone and Liberia, preferably at least one of Mauritania, Senegal, Gambia, and Guinea-Bissau (and preferably not farther than ten miles off said coast), may be identified as a pre-hurricane system if at least one measurement of atmospheric pressure is between about 27 inches and about 29 inches (more preferably, more than one measurement; most preferably, an average of measurements taken throughout the system), and if the temperature of the ocean water associated with the low pressure system is more than 75 F, for instance between about 75 F and about 85 F, preferably more than 80 F. The measurement of temperature of ocean water is well-known in the arts; any reliable means for measuring temperature may be used. Preferably, the temperature is measured by thermometer.

A pre-hurricane system may also be identified by a combination of low atmospheric pressure of a given low pressure system in combination with at least one of the temperature of the associated ocean water, the presence of several other low pressure systems in the area, the physical size of the low pressure system.

Cooperation with these African countries shouldn't be difficult as local officials are probably measuring these systems as they cross their country. The major cities of these countries are located on the western coast where the rainfall is the heaviest and even with basic meteorological equipment, the depth of low pressure can be measured.

To monitor, measure and attack the systems requires an air base near the area. Preferably, the air base is off the west coast of these countries, beyond the 3 mile territorial limit, for easy access to the systems as the continental countries involved might demand their approval for flying over their countries. Beyond the 3 mile territorial limit, none of these countries could claim sovereignty over the surveillance area, and the air base may be more difficult to target for political reasons than an airbase within another country's territory.

A preferred location is the Cape Verde Islands. They are just north of the tropical rain belt and 300 miles west of Senegal. They have prevailing northeast winds which create steady, predictable flying conditions. Even though it is near the tropical rainbelt, its climate is semi-arid and drought is not uncommon which means air surveillance and other flights would not have many interruptions because of adverse weather conditions. It has a slight, rainy period (mainly August-September) but rainfall is low and unreliable. There is an international airport at the city of Pedra Lyme which could probably be used under a lease agreement. Other islands in the group might also be available. The islands are about as close to the storm passage west as possible without being part of the tropical rain belt, thereby shortening the distance to the surveillance and possible attack area.

Step 2: Inducing Rainfall

To induce rainfall in a low pressure system identified as a pre-hurricane system, any number of techniques known in the art may be used, including but not limited to “seeding” with dry ice, silver iodide and nuclear condensation.

It is easier to attack low pressure systems while they are still weakening storms coming off the African coast, it is easier to approach and influence an already weakening system than a developing hurricane.

Without being bound by theory, it is believed that the more rain a low pressure system releases, the weaker it becomes. The low pressure within the storm begins to rise as more rain is released, thus weakening the storm.

The coastal areas receive the most rain which indicates the storms are in full progress. According to the present invention, the lower pressure, suspectedly stronger storms are to be seeded to stimulate additional rainfall, preferably once they clear the 3 mile territorial limit. This further weakens the low pressure systems, so that they lose sufficient strength and are not able to avail themselves of the fuel of the ocean later. They gradually disorganize and disappear.

There has been some success with cloud seeding using dry ice, silver iodide and nuclear condensation. The present invention would preferably use a small fleet of airplanes capable of distributing tons of “seed” material into the systems to stimulate additional rainfall.

Preferably, a meteorological airbase is established, preferably on the Cape Verde Islands. The airbase would have the capacity for a fleet of airplanes capable of “seeding” low pressure systems moving off the western coast of Africa, where the systems are identified as low pressure systems having the potential to become a hurricane. The seeding preferably begins beyond the territorial waters of nearby African or other countries. The seeding forces additional rainfall from these systems to sufficiently weaken them and reduce or preferably eliminate their capacity to develop into a hurricane, or at least reduce the strength of a hurricane.

As storms begin to increase their level of organization, a noticeable eye, the center of the storm, begins to form around which winds rotate in a counter-clockwise circular direction gradually increasing in velocity. As the wind velocity rises, the eye begins to shrink, becomes more tightly organized and the atmospheric pressure begins to drop. The precise causative order of these events is not totally understood, e.g., whether the lowering of the atmospheric pressure causes wind velocity to increase or the increase in wind velocity causes the atmospheric pressure to decrease. The ultimate objective is to lower wind velocity as lower atmospheric pressure does little or no damage unless lower atmospheric pressure is the cause of the increase in wind velocity.

Without being bound by theory, the circulation of the winds around the eye coupled with the natural upward rising of air from the warm ocean water provides the energy to power the hurricane's development. The continual influx of energy into the system is transferred into the rotating winds around the eye increasing the rotating wind velocity, which energy, if reduced, would create a vulnerability in the system. If we attack the “head”, the eye, we can attempt to reduce the severity of the storm.

By interfering with the surrounding winds around the eye, we disturb or disrupt those immediate most dangerous winds around the eye and partially disorganize the system dropping it from say a Category 4 to a Category 2 system, according to US government classification standards. The higher the wind velocity the more difficult they should be for the hurricane to control and, therefore, more susceptible to disorganization. The faster a wheel spins increases the possibility of something going wrong and it takes less interference to affect it.

A method according to the present invention is to identify a hurricane and its eye, and preferably other parameters typically identified when evaluating hurricanes, including but not limited to inner wind parameters such as wind speed and direction (velocity), breadth and depth. (For the purposes of this invention, “inner wind” refers to winds surrounding, circling, forming the eye of the hurricane, possibly extending out 20-25 miles from the eye, or possibly only for instance 8-10 miles). The method further comprises introducing a “plug” as discussed below (i.e. N-block), by dropping a quantity of a water-absorbent material such as oatmeal, over at least one portion of the hurricane. Preferably, the plug is applied near the eye of the hurricane, so the plug (i.e. N-block) is dropped so as to form a roughly perpendicular block to the inner winds. By roughly perpendicular, is meant that the plug will block, disrupt and/or redirect windflow. Preferably, the plug reaches across at least 20% of the identified breadth of the inner winds surrounding the eye, more preferably at least 30% across, still more preferably at least 50% across. Preferably, the plug is at least about 0.5 to 12.5 miles long, reaching out from the eye of the hurricane, more preferably about 1 to 10 miles, 2 to 8 miles, or 3 to 4 miles across. The bigger the hurricane, the larger the plug. The closer to the eye, the better, as well. More than one plug (i.e. N-block) may be applied to a given hurricane, at about the same time or sequentially, one block after another.

To attack these winds, a water absorbent material is used, preferably oatmeal. It's cheap, available, an American product, light-weight so airplanes can carry huge amounts of it, absorbent in water (rain), environmentally friendly, easily stored and when soaked up with water becomes heavier and aerodynamically disparate which would create considerable disruption and eddying in the hurricane's high speed airflow. Weight-wise, it may increase its weight for instance by a factor of 3 to 5, preferably 4. For instance, if 300 tons of oatmeal were dropped into a given area, it could produce up to 1200 tons of weight resistance as it soaks up rainwater. Oatmeal would be consumed by ocean creatures and cause little or no environmental concerns. Preferably, the oatmeal is milled into a large flake size, within the context of normal oatmeal flakes.

The method is to attack the hurricane near its center close to the eye. The storm has become more organized, its inner wind velocity is increasing, its atmospheric pressure is lowering, e.g., a Category 4 storm. In terms of orientation, the front of the storm, the direction it is moving would be 12 o'clock. For the purpose of the below discussion and Figures, if the hurricane would be moving north, the front would be 12 o'clock, west would be 9 o'clock, east 3 o'clock and south would be 6 o'clock.

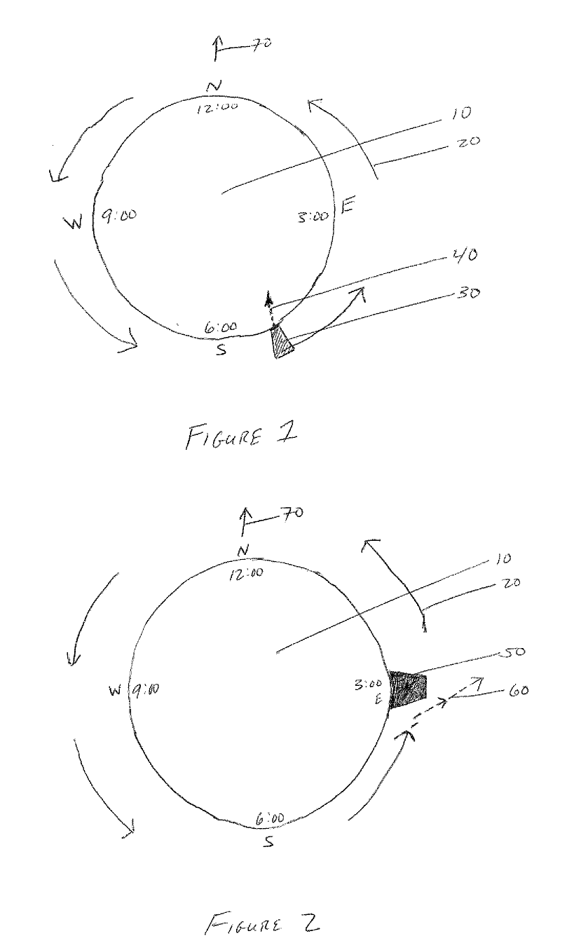

As the hurricane is spinning counter-clockwise, a fleet of 20-25 or more airplanes loaded with oatmeal or other water absorbent material approach the storm from a preferably 4:30 o'clock position in a wedge-shape formation. Like a piece of pie. See FIG. 1, showing a hurricane eye (10), inner winds around the eye (20), and an inward N-block (30), in a wedge-shape. The 4:30 position is for illustration and discussion purposes and is not meant to be limiting. Other positions may also be used. The inward N-block may be applied at other o'clocks of the eye as well, preferably 4:00 to 5:00, most preferably about the 4:30 position. At an altitude of 3500-4000 feet (estimated), (or other distances above the hurricane, safe for airplane travel), about 5 miles or so (again estimated—preferably 2-7 miles, more preferably 3-6 miles, more preferably 4-5 miles, and most preferably about 5 miles), from the southeast edge of the hurricane's eye, the planes would begin releasing large amounts of oatmeal such as 10-30 tons, preferably 15-25 tons, more preferably 18-22 tons, most preferably about 20 tons, or other highly water absorbent material all the way to the eye of the storm but, preferably, not into the eye. Preferably, the total amount of oatmeal dropped in an N-block of the present invention will be about 200-700 tons, more preferably about 300-500 tons. The simultaneous release of the oatmeal and/or other water-absorbent substance will form the wedge-shaped inward N-block (30), disrupting the inner winds (2) around the eye (1) and preferably directing the winds into the eye. See FIG. 1 reference 40, indicating the projected path of inner winds after forming the inward N-block (30). Preferably, the oatmeal is released in the shape of a wedge, where the wedge is about 100-400 feet, preferably 200-300 feet, most preferably about 200 feet across at the narrower end of the wedge, near the eye of the storm, and about 500-1000 feet, preferably 600-900 feet, more preferably 600-800 feet across at the broader end of the wedge, away from the eye of the storm. Dropping oatmeal into the eye, which is relatively quiet, would be of little value. Preferably, the airplanes fly at a speed and direction (velocity) similar to or the same as the hurricane wind speed, to maximize distribution of the oatmeal.

Timely release of the oatmeal would require careful planning. The above example is illustrative. Releasing simultaneously is preferred.

After the Second World War ended, it was necessary to repair holes in the dikes in the Netherlands the Germans had blown in them. Past practice pushed dirt in from the sides until they finally filled the gap. American engineers figured out a better way. The built a platform over the gap and heaped dirt on the platform. When they had sufficient dirt on the platform to fill the gap, they simultaneously blew out the outer supports of the platform and let it drop into the gap. Instant plug. I am calling my plug an N-Block or MRB, mobile resistance block.

This would be impossible to duplicate perfectly with airplanes but a formation may approach the plug idea as close as safely possible. The theory is to create instant maximum resistance, instant maximum aerodynamic chaos in a chosen area, all with the intention of disorganizing the storm to reduce it 2-3 categories if possible. As these systems approach Category 3 status and higher, they become more dangerous and destructive but they also become more fragile and vulnerable and, thus, attackable.

The planes would enter the attack area around the 4:30 position and aim their flight around toward the 1 o'clock position, that is, in the direction of the inner winds surrounding the eye of the hurricane. If you flew into the area perpendicular to the hurricane's winds, there would be considerable scattering of the water absorbent material. By aiming toward 1 o'clock would reduce the scattering as the planes would be flying partially with the winds. The more material concentrated in one area, the more resistance and disorganization will occur.

As indicated above, One possible MRB, (See FIG. 1) would be a wedge configuration to the MRB plug with the outer end being the thickest. Outer meaning away from the storm's eye with more resistance proceeding outward from the eye than inward toward the eye. The winds coming around the corner (6 o'clock) push into this resistance and will have to alter direction. By having less resistance toward the eye, the winds should partially begin blowing toward the eye and into the eye. This should cause more disruption by blowing toward the eye and, by blowing into the eye, should raise atmospheric pressure, creating more disorganization, causing a loss in strength.

A repeat note should be made about oatmeal. It will absorb 3-4 times its weight in water in a short time, 3-4 minutes. By releasing the oatmeal from around 3,500-4,000 feet, or other distance about the storm safe for plain flight but close enough to effect a plug, it being as light as it is, it will slowly descend and increase its weight by 3-4 times before falling into the sea. As it falls, its weight will change and further wind disorganization should occur. The surface winds of the storm create the storm surge and land surface damage. This will be when the material should be causing its greatest resistance. The storms must remain organized to maintain and increase their strength. A key to weakening them is to introduce disorganization.

Timing is also a factor. It is less preferable to attack a hurricane 300 miles away from our shores. It might reorganize itself and continue to become a threat.

The storms would have to be followed, charted and their speed and path carefully determined as they are now. Commonly, they travel between 6-9 miles per hour (mph) for instance, let us say 8 mph. That means it will take about 12 hours to travel 100 miles to landfall. Also, hurricanes tend to weaken during evening and nighttime hours. It's theorized the loss of the sun's daylight energy plays a part. The best scenario is to attack as close to sunset as possible within 100 miles or so of landfall. Preferably, the present invention will result in a drop of 2 or more categories. The goal would be to reduce the maximum inner wind velocities to 100 mph or less. The massive wind damage and ocean storm surge worsen as the winds increase so any reduction would be beneficial.

In the example just described (and FIG. 1), using an N-Block (which is also referred to as MRB-Mobile Resistance block) the tactic is to disorganize the inner winds surrounding the eye and attempt to divert some of the winds inward into the eye. Using the same idea but diverting the winds outward similar to a tire blowing out will also weaken a hurricane. For the purposes of the present invention, a wedge-shape is preferred for disrupting winds. Other shapes may be used as well. As the winds spin counter-clockwise around the storm's eye, four good points of possible attack are identified in FIG. 2—12 o'clock, 9 o'clock, 6 o'clock and 3 o'clock. At these points, there are directional changes. For instance, winds proceeding from 6 o'clock to 3 o'clock are traveling northeastward and from 3 o'clock to 12 o'clock, they are moving northwestward. These points are meant to be illustrative as in FIG. 2, and preferred, but not limiting. A point of directional change and maximum outward centrifugal force could create a vulnerability point for using an N-block (MRB) but reversing the direction of the wedge shape. For instance, FIG. 2 shows a method similar to that described for FIG. 1, but with an outward N-block (50) with the projected path of inner winds after the outward N-block (60) showing diversion of inner winds (20) away from their path around the eye (10). The direction of storm movement in all Figures is indicated as well (FIGS. 1-3: 70; FIG. 4: 80). Have the thickest part nearest the eye and the thinnest part outward just the opposite as the one previously described. The idea is to divert winds outward much as a tire does when it blows out. The purpose being to disrupt the counter-clockwise spin of the winds and send them off in another outward direction to disorganize the storm. High speed winds out of control would hopefully have a devastating effect on the storm's organization causing weakening and loss of wind velocity.

A combination of the two MRB “attacks” may also be used. By using an inward MRB on one side of the storm and an outward MRB (Blowout) on the other side of the storm's eye may have a cumulative effect on the storm.

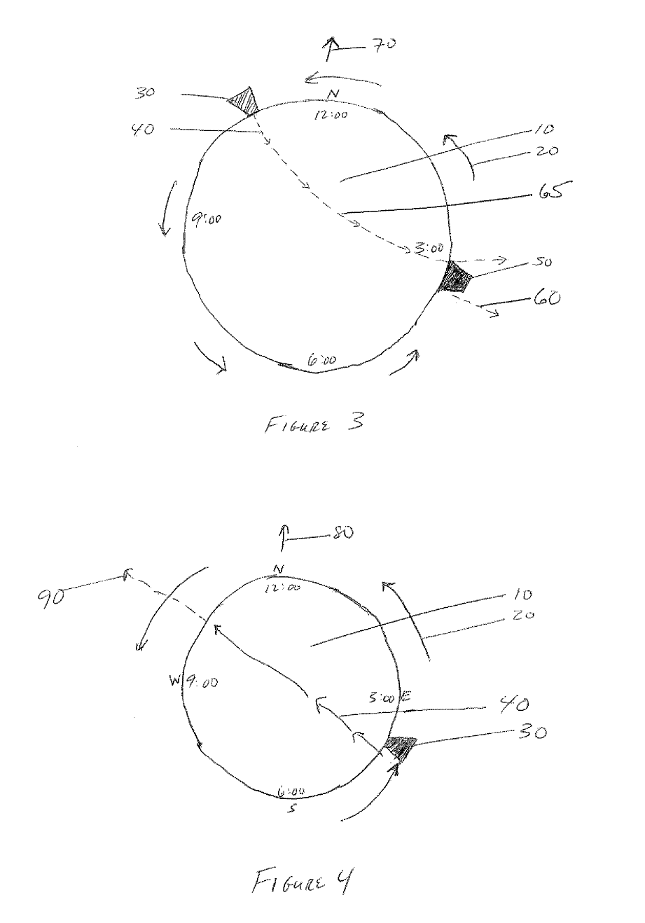

One embodiment of the present invention including a dual attack is illustrated in FIG. 3. By introducing an outward MRB (50) (Blowout) around 4 o'clock and forcing winds outward while simultaneously introducing an inward MLB (30) at about 10 to 11 o'clock will preferably create a current of wind from 10 to 11 o'clock towards 4 o'clock (65) through the eye (10) of the hurricane. This should raise the atmospheric pressure within the eye and, hopefully, reduce the hurricane's strength. Without being bound by theory, the strength of the winds coming from 12 o'clock towards 9 o'clock and diverting them inward should increase the inward pressure into the eye as well as disrupting the normal flow of the eye surrounding winds. By increasing the pressure from the inward winds from 10 o'clock and reducing pressure (Blowout) at 4 o'clock should create a crosswind and making it easier for inward winds to penetrate into the eye. By disrupting the high velocity winds on opposite sides of the storm, simultaneously, should cause maximum disruption to the storm. Simultaneous does not only mean precisely but may mean close to the same time. However, outward is preferably first.

In another method for influencing hurricane behavior, if the N-Block achieves a degree of success and winds are diverted into the eye, the eye of the storm may experience a directional change from direction just before introduction of the inward N-block (80) to direction after dispersion of the winds (90). The winds blowing in from a 4:30 position would blow against the 11:00 to 10:00 counter-clockwise wind area from the inside out. See FIG. 4, showing a directional change caused by an inward N-block. these winds would be colliding with the counter clockwise winds at an angle of interception approaching 90 degrees. This may cause not only inner wind disruption but possible directional change of the storm's eye. A directional change different from its normal path might also adversely affect the storm's performance. An N-block in a different position will allow for different directional changes.

This collision could cause a change in direction of the eye towards the left. If a hurricane is headed towards a particularly sensitive land area, e.g., Katrina, any change in another direction would be valuable. This interaction near the top-front part of the eye should have a greater effect on the eye than say the same interaction on the lower part of the eye in terms of directional change. For instance, when hurricanes would be located in the Eastern Caribbean, they would be proceeding westward and drifting just north of the tropical doldrum area. An attack would be made to cause a directional change of the eye toward the south into the doldrum area so that it would lose its westward progression and could spin itself out in the Southern Caribbean. By varying the point of entry of the inward. N-Block could increase the range of possible directional changes.

There is another method of attack according to the present invention. The storms are generated and develop in warm, moist conditions with the tropical waters being an ideal generator. Hurricanes require water temperatures of 84-85 degrees and above. Without being bound by theory, as the storm is spinning, it is pulling itself forward which permits it to feed on a fresh supply of warm air and moisture. As the storm intensifies, the eye becomes smaller and more defined. The smaller the eye becomes, the easier it is to attack.

This method is to attack the storm by cooling the air in front of the eye of the storm. If the eye of the storm has reduced itself to 25 miles in diameter, e.g., air planes would drop small pellets of dry ice directly in the path of the storm. The reason is to attempt to cool the air directly above the ocean surface and in front of the storm's eye. The planes would follow the contours of the eye and attack in the same counter-clockwise direction of the winds but just ahead of it. The point of attack would be from 2 o'clock around towards 10 o'clock with the front of the advancing storm being 12 o'clock. By flying with the winds at a speed as near to the storm's wind velocity as possible, the carbon dioxide pellets would not be scattered too widely by speed differences. It would be easier for pilots and airplanes to execute as well.

Specially equipped planes and trained pilots will be necessary. The winds of hurricanes are strong and unpredictable. Preferably, twenty-five planes or more will be used, more preferably 2-3 or more abreast flying 250-300 feet above the ocean surface, perhaps 750-1000 feet behind each other, flying in formation so their oatmeal loads will when dropped at the same or nearly same time form a plug or N-block of the present invention. The altitude would depend on the length of time it would take for the dry ice pellets to evaporate before hitting the ocean water. The pellets landing in the water wouldn't help much. The cold air would settle by itself. Even a 2-3 degree temperature change in that restricted area could possibly have a weakening effect on the storm. The temperature change is preferably a temperature decrease in the amount of 1-10 degrees Fahrenheit, more preferably 2-9 degrees Fahrenheit, more preferably 3-8 degrees Fahrenheit, more preferably 3-7 or 3-6 degrees Fahrenheit, most preferably 3-5 degrees Fahrenheit. The point is to cool the air close to the ocean's surface, not the ocean water. With a storm moving at around 12 feet per second, it should not be too difficult to place the dry ice pellets directly in the path of the storm. The idea is similar to a car. Cut off or reduce the gasoline to the engine and you can adversely affect the engine's performance.

A basic problem of hurricane control is: From where and how does the hurricane obtain the new energy it uses to increase its size, strength and wind velocity? It is apparently able to obtain fresh energy from the warm ocean water via the winds spinning around the eye. Most of the energy must be absorbed by the front of the storm (9 o'clock to 12 o'clock to 3 o'clock) as the winds from the back portion (3 o'clock to 6 o'clock to 9 o'clock) are traveling over waters that have already been passed over. But if the hurricane can increase its severity by feeding small amounts of energy into it then it would seem likely it could be weakened by reducing the amount of energy available to it. This would be done by cooling the air it uses.

Preferably, the point of where to introduce the dry ice is to place it as close as possible to the front (12 o'clock) counter-clockwise advancing winds or slightly within them. The best location would be from wherever the storm is drawing most of its energy.

Once it has been decided approximately where to introduce the dry ice, the next question becomes how wide an area should be cooled. If it is too wide, the air may warm up before the advancing front arrives and be of little value. Preferably, the area is 150-200 yards wide, as close as possible to the advancing winds and moving just ahead of the storm at the same speed.

Preferably, the invention is to slightly cool the warmer air rising from the ocean's surface and cool it sufficiently to affect the storm's functioning to reduce the storm's strength. It is recognized that these storms are not precisely delineated.

These are awesome storms but we must not be overawed by them. They have their vulnerabilities. They lose strength quickly after they meet resistance at landfall, lower air and water temperatures can hinder their development and loss of strength from loss of sunlight are among their vulnerabilities. They have little self-propulsion capability and as they increase to higher categories, the high wind velocity must create openings to disrupt the system. We can learn to use its own strength against itself. The overall storms are huge but the center (eye) is small and vulnerable. Strike the eye and immediate surrounding winds as this is where the major danger and harm come from.

Releasing tons of oatmeal or other water absorbent material from an altitude of 3500-4000 feet is preferable. However, a higher or lower altitude may also be part of the present invention. The objective is to create the greatest disruption near the ocean surface. The lower surface winds provide the power to create the devastating storm surges and severe surface property damage.

Computer models may be used to determine the best relationship between the length, width and height of a N-Block and the amount of water absorbent material to produce maximum or desirable disruption of a storm. Each storm will be considered as a separate entity. Reducing wind velocity by disrupting the storm's organization and, thereby, lowering the storm surge will be a primary objective.

Due to the unique nature of each hurricane, each hurricane will need to be independently evaluated in order to tailor methods of the present invention to the hurricane.

I claim:

1. A method for suppressing the development of a hurricane comprising the steps of:
a. identifying a low pressure system as a pre-hurricane system, and
b. inducing rainfall within the pre-hurricane system.

2. The method of claim 1, wherein said low pressure system is a system having an atmospheric pressure of not more than about 29.5 inches, preferably not more than about 27 inches.

3. The method of claim 2, wherein said atmospheric pressure is between about 27 and about 28.5 inches, and wherein said low pressure system is further monitored for a decrease in atmospheric pressure.

4. The method of claim 2, wherein the low pressure system has an atmospheric pressure of between about 27 and 29 inches and wherein ocean water associated with the pre-hurricane has a temperature of greater than about 75 degrees Fahrenheit.

5. The method of claim 1, wherein said low pressure system is identified between June 1 and December 1 according to the United States calendar, more preferably between July 1 and November 1, most preferably between August 1 and November 1.

6. The method of claim 1, wherein said low pressure system is located off of the territorial limits of the western coast of at least one of the group consisting of Mauritania, Senegal, Gambia, Guinea-Bissau, Guinea, Sierra Leone and Liberia.

7. A method for weakening a hurricane comprising the steps of:
a. identifying the hurricane,
b. identifying the eye of the hurricane, and
c. introducing a plug of a water absorbent material over at least one portion of inner winds surrounding the eye of the hurricane.

8. The method of claim 7, wherein in step a, the hurricane is identified as a Category 1, 2, 3, 4 or 5 hurricane, according to current United States hurricane classifications.

9. The method of claim 8, wherein in step a, the hurricane is identified as a Category 3, 4 or 5 hurricane.

10. The method of claim 8, wherein in step a, the hurricane is identified as a Category 4 or 5 hurricane.

11. The method of claim 7, wherein in step b, the radius of the eye of the hurricane is identified.

12. The method of claim 11, wherein in step b, the flow and breadth of inner winds surrounding the eye of the hurricane is identified.

13. A method of causing a directional change in a hurricane comprising the step of cooling the air in front of the hurricane so that the hurricane changes direction.

14. The method of claim 13, wherein said cooling is a decrease in temperature of at least 2 degrees Fahrenheit.

15. The method of claim 13, wherein said air is cooled by dropping dry ice.
